(19) United States
(12) Patent Application Publication
(10) Pub. No.: US 2013/0111400 A1
(43) Pub. Date: May 2, 2013

(54) MOBILE TERMINAL AND FOLDER MANAGING METHOD

(71) Applicant: KYOCERA CORPORATION, Kyoto-shi (JP)

(72) Inventor: Tomoaki MIWA, Osaka (JP)

(73) Assignee: KYOCERA CORPORATION, Kyoto-shi, (JP)

(21) Appl. No.: 13/626,866

(22) Filed: Sep. 25, 2012

(30) Foreign Application Priority Data
Sep. 27, 2011 (JP) 2011-210059

(51) Int. Cl. G06F 3/0481

(52) U.S. Cl. CPC G06F 3/04817
USPC 715/808; 715/835

(57) ABSTRACT

A mobile phone (10) includes a flash memory (32) in which folders are set, a camera module, etc., and performs a camera function. In a state that the camera function is being performed, a through image and a saving folder icon (F1) corresponding to a saving folder are displayed. If a touch operation is made to the saving folder icon (F1), folder icons (F1-F3) corresponding to the folders are simultaneously displayed. If and when an arbitrary folder icon out of the folder icons displayed simultaneously is selected by a touch operation, a setting of the saving folder is changed. Then, if a user performs an imaging operation, an imaged image is saved in a changed saving folder changed.

### CROSS REFERENCE OF RELATED APPLICATION

The disclosure of Japanese Patent Application No. 2011-210059 is incorporated herein by reference.

### BACKGROUND OF THE INVENTION

1. Field of the Invention

The present invention relates to a mobile terminal and a folder managing method, and more specifically, a mobile terminal and a folder managing method, capable of imaging an image.

2. Description of the Related Art

One example of a mobile terminal capable of imaging an image is disclosed in a related art. A digital camera of the related art produces a new folder in a case that a predetermined change in the data and time occurs, and a file of an imaged image is recorded in this new folder.

In the digital camera of the related art, in a case that an imaging is performed many times in the same day, a number of imaged image files are to be recorded within the same folder. Therefore, it is troublesome to classify such a number of imaged image files recorded in the single folder according to the contents thereof. Furthermore, in a case that a folder in which an imaged image is saved is to be changed, a user must perform a complicated operation.

### SUMMARY OF THE INVENTION

Therefore, it is a primary object of the present invention to provide a novel mobile terminal and folder managing method.

Another object of the present invention is to provide a mobile terminal and folder managing method capable of increasing operability at a time that an imaging is performed.

The present invention employs following features in order to solve the above-described problems. It should be noted that reference numerals and the supplements inside the parentheses show one example of a corresponding relationship with the embodiments described later for easy understanding of the present invention, and do not limit the present invention.

A first aspect according to the present invention is a mobile terminal which includes a camera module and a display portion displaying an image that the camera module outputs, and performs a camera function, comprising: a storing portion in which at least a folder is set; a displaying processing portion which displays a through image on the display portion based on an output of the camera module; an icon displaying processing portion which displays an icon corresponding to the folder in a selectable manner at a time that the through image is being displayed by the displaying processing portion; a setting portion which sets a folder corresponding to a selected icon as a saving folder in which an imaged image is saved; and a saving portion which saves an imaged image in the saving folder that is set by the setting portion when an imaging operation is performed.

A second aspect according to the present invention is a folder managing method of a mobile terminal which includes a storing portion in which at least a folder is set, a camera module, a display portion which displays an image output by the camera module, and performs a camera function, comprising steps of: displaying a through image on the display portion based on an output of the camera module; displaying an icon corresponding to the folder in a selectable manner at a time that a through image is being displayed; setting a folder corresponding to a selected icon as a saving folder in which an imaged image is saved; and saving an imaged image in the saving folder at when an imaging operation is performed.

A third aspect according to the present invention is a mobile terminal which includes a camera module, a display portion displaying an image that the camera module outputs, a touch panel provided on the display portion and a detecting portion detecting a touch operation within a touch range of the touch panel, and performs a camera function, comprising: a storing portion in which at least a folder is set; a displaying processing portion which displays a through image on the display portion based on an output of the camera module; a region setting portion which sets a specifying region corresponding to a folder within the touch range when a through image is being displayed by the displaying processing portion; a saving folder setting portion which sets, when a touch operation is made to the specifying region, a folder corresponding to the specifying region as a saving folder in which an imaged image is saved; and a saving portion which saves an imaged image in the saving folder set by the setting portion when an imaging operation is performed.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing electrical structure of a mobile phone of an embodiment according to the present invention.

FIGS. 2(A) and 2(B) each is an appearance view showing one example of an appearance of the mobile phone shown in FIG. 1, and FIG. 2(A) shows a front side appearance of the mobile phone and FIG. 2(B) shows a rear side appearance of the mobile phone.

FIG. 3 is an illustrative view showing one example of structure of a folder table stored in a RAM shown in FIG. 1.

FIG. 4 is an illustrative view showing examples of a through image and a pop-up both displayed on a display shown in FIG. 1.

FIG. 5 is an illustrative view showing one example of a through image displayed on the display shown in FIG. 1.

FIGS. 6(A) and 6(B) each is an illustrative view showing one example of a procedure of an operation by which folder icons are simultaneously displayed on the display shown in FIG. 1, and FIG. 6(A) shows one example of a state that an operation to a changing icon is performed and FIG. 6(B) shows one example of a state that folder icons are simultaneously displayed.

FIGS. 7(A) and 7(B) each is an illustrative view showing one example of a procedure of an operation by which folder icons are simultaneously displayed on the display shown in FIG. 1 is changed, and FIG. 7A shows one example of an operation for changing the folder icon and FIG. 7(B) shows one example of a result that the folder icons being simultaneously displayed is changed.

FIGS. 8(A) and 8(B) each is an illustrative view showing one example of a procedure of an operation by which a saving folder is set with using the folder icons simultaneously displayed on the display shown in FIG. 1, FIG. 8(A) shows one example of an operation to the folder icon and FIG. 8(B) shows one example of a state that a saving folder is newly set.

FIGS. 9(A) and 9(B) each is an illustrative view showing one example of a procedure of another operation by which a saving folder is set with using the folder icons simultaneously displayed on the display shown in FIG. 1, FIG. 9(A) shows one example of an operation to a new saving folder and FIG. 9(B) shows one example of a state that a newly produced folder is set as the saving folder.

FIGS. 10(A) and 10(B) each is an illustrative view showing one example of a procedure of a further operation by which a saving folder is set with using the folder icons simultaneously displayed on the display shown in FIG. 1, and FIG. 10(A) shows one example of a state that an operation to a plurality of folder icons is performed and FIG. 10(B) shows one example of a state that a plurality of folder icons are set.

FIGS. 11(A)-11(D) each is an illustrative view showing one example of a procedure of an operation by which two (2) consecutive shooting folders are set with using the folder icons simultaneously displayed on the display shown in FIG. 1, and FIG. 11(A) shows one example of a displaying of a state that a consecutive shooting function of a camera function is set, FIG. 11(B) shows one example of an operation for setting a first consecutive shooting folder, FIG. 11(C) shows one example of an operation for setting a second consecutive shooting folder and FIG. 11(D) shows one example of a state that the consecutive shooting folder is set.

FIG. 12 is an illustrative view showing one example of a state that an arrangement of the folder icons simultaneously displayed on the display shown in FIG. 1 is changed.

FIG. 13 is an illustrative view showing one example of a memory map of the RAM shown in FIG. 1.

FIG. 14 is a flowchart showing one example of a part of a folder managing process by a processor shown in FIG. 1.

FIG. 15 is a flowchart showing one example of another part following FIG. 14of the folder managing process by the processor shown in FIG. 1.

FIG. 16 is a flowchart showing one example of an imaging process by the processor shown in FIG. 1.

FIG. 17 is an illustrative view showing another example of a through image displayed on the display shown in FIG. 1.

FIGS. 18(A) and 18(B) each is an illustrative view showing another example of a procedure of an operation by which folder icons are simultaneously displayed on the display shown in FIG. 1, and FIG. 18(A) shows one more example of a state that an operation to a change specifying region is performed and FIG. 18(B) shows one example of a state that a plurality of folder specifying regions are simultaneously displayed.

### DETAILED DESCRIPTION OF THE PREFERRED EMBODIMENTS

### First Embodiment

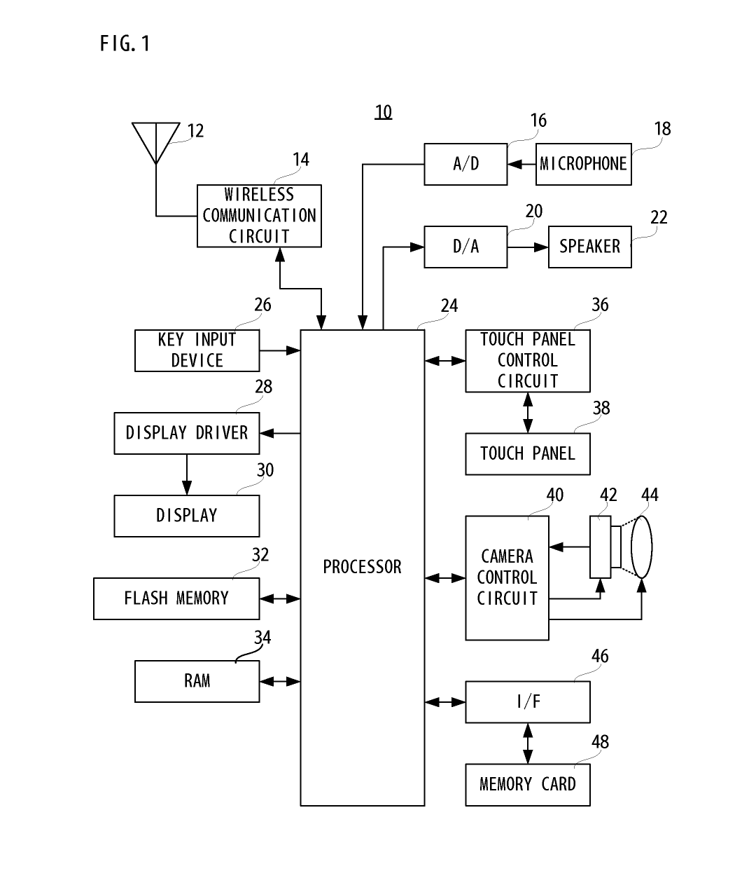

With referring to FIG. 1, a mobile phone 10 is a kind of a mobile terminal, and includes a processor 24 called as a computer or a CPU. The processor 24 is connected with a wireless communication circuit 14, an A/D converter 16, a D/A converter 20, a key input device 26, a display driver 28, a flash memory 32, a RAM 34, a touch panel control circuit 36, a camera control circuit 40, an interface (hereinafter, called as I/F) 46, etc.

An antenna 12 is connected to the wireless communication circuit 14. A microphone 18 is connected to the A/D converter 16 and a speaker 22 is connected to the D/A converter 20. The display driver 28 is connected with a display 30. A touch panel 38 is connected to the touch panel control circuit 36. The camera control circuit 40 is connected with an image sensor 42 and a motor which adjusts a lens position of a focus lens 44. Then, a memory card 48 is attachably/detachably connected to the I/F 46.

The processor 24 is in charge of a whole control of the mobile phone 10. The RAM 34 is used as a working area (including a drawing area) or a buffer area for the processor 24. The flash memory 32 functions as a storing portion, and is stored with data of contents of the mobile phone 10 such as characters, images, sounds, voices and videos.

The A/D converter 16 converts an analog sound signal of the sound or voice input through the microphone 18 into a digital sound signal. The D/A converter 20 converts (decodes) a digital sound signal into an analog sound signal so as to apply to the speaker 22 via an amplifier not shown. Therefore, a sound or voice corresponding to the analog sound signal is output from the speaker 22.

In addition, the processor 24 adjusts a sound volume of the sound output from the speaker 22 by controlling an amplification factor of the amplifier (not shown) connected to the D/A converter 20.

The key input device 26 functions as an operating portion, and includes a call key 26a, an end key 26b, a function key 26c, etc. Information (key data) of the key operated by the user is input to the processor 24.

The display driver 28 controls the displaying of the display 30 connected to this display driver 28 under instructions by the processor 24. In addition, the display driver 28 includes a video memory (not shown) which temporarily stores the image or video data to be displayed. The display 30 is provided with a backlight which includes a light source of an LED on the basis of an edge light system, and a display panel of the display 30 is lightened by the backlight. In addition, a light source of the backlight may be a cold cathode ray tube or the like.

The touch panel 38 detects that one or more fingers is brought into contact with the touch panel 38 by electrostatic capacitance system that a change of an electrostatic capacitance between electros which occurs when an object such as a finger is in close to a surface of the touch panel, for example. In addition, the touch panel 38 is a pointing device which is provided on the display 30 and designates an arbitrary position within a screen of the display. The touch panel control circuit 36 functions as a detecting portion, and detects a touch operation such as pushing, stroking, contacting within a touch-effective range of the touch panel 38, and outputs coordinates data indicative of a position of the touch operation to the processor 24. That is, the user can input an operating position, an operating direction and so on to the mobile phone 10 by pushing, stroking or contacting to the surface of the touch panel 38 with his/her finger.

Here, an operation that the user brings his/her finger into contact with an upper surface of the touch panel 38 is called as “touch”, and an operation that the finger is released from the touch panel 38 is called as “release”. Furthermore, an operation that the user touches the upper surface of the touch panel 38 and then releases his/her finger from the surface is called as “touch-release”.

Furthermore, an operation stroking the surface of the touch panel 38 is called as “slide”. Furthermore, an operation that the touch-release operation is performed twice consecutively is called as “double-touch” and an operation touching two positions simultaneously or approximately simultaneously is called as “multi-touch”. Then, the term “touch operation” includes the operations of the above-described touch, release, touch-release, slide, double-touch, multi-touch and so on.

Furthermore, coordinates designated by the touch operation is called as “touch point” (a touch start position), and coordinates designated by the release operation is called as “release point” (touch end position).

In addition, a touch operation is not limited to an operation by a finger, may be performed by a touch pen that an electric conductor is attached at a tip end thereof or the like. Furthermore, for a detection system of the touch panel 38, a surface-type electrostatic capacitance system may be adopted, or a resistance film system, an ultrasonic system, an infrared ray system, an electromagnetic induction system or the like may be adopted.

The camera control circuit 40, the image sensor 42 and the focus lens 44 are collectively called as a camera module, which is utilized for imaging a still image or a moving image on the mobile phone 10. For example, if a key operation or a touch operation for performing a camera function, the processor activated the camera control circuit 40 to perform the camera function.

In an imaging area of the image sensor 42, photo-receiving elements corresponding to UXGA (1600×1200 pixels) are formed. Therefore, if an optical image of an object is irradiated to the image sensor 42, due to the photoelectric conversion in the imaging area, charges corresponding to the optical image of the object, that is, a raw image signal of UXGA is produced.

If the camera function is performed, in order to display a real time moving image of the object, i.e. a through image (a preview image), the processor 24 activates an image sensor driver incorporated within the camera control circuit 40, and instructs the image sensor driver to make an exposure operation and a read operation of the charges corresponding to a designated read area.

The image sensor driver performs an exposure on an imaging surface of the image sensor 42, and a read-out of the charges produced by the exposure. As a result, a raw image signal is output from the image sensor 42. The output raw image signal is input to the camera control circuit 40 which conducts to the input raw image signal the processing of color separation, white balance adjustment, YUV conversion and so on, thereby to produce image data of YUV format, which is then input to the processor 24.

The image data of the YUV format input to the processor 24 is stored (temporarily stored) in the RAM 34 by the processor 24. At this time, the processor 24 outputs a thinning read instruction to the display driver 28, which outputs the image data of YUV format to the display 30 according to the thinning read instruction issued from the processor 24. Accordingly, a low resolution (320×240 pixels, for example) through image representing an objective scene is displayed on the display 30.

Here, the camera control circuit 40 calculates a focus evaluation value from the raw image signal, and outputs the focus evaluation value to the processor 24. The processor 24 performs an AF processing based on the focus evaluation value output from the camera control circuit 40. During the AF processing, the camera control circuit 40 adjusts a lens position of the focus lens 44 under instructions by the processor 24. As a result, a through image bringing the object into focus is displayed on the display 30.

Next, if an imaging operation of a still image is performed, the processor 24 outputs an executable instruction of a main imaging process for a still image to the camera control circuit 40. When the executable instruction is issued, the camera control circuit 40 performs the above-described respective processing on the UXGA raw image signal output from the image sensor 42 so as to output the image data of the YUV format to the processor 24. The processor 24 converts (compresses) the image data of the YUV format to the image data of a JPEG format to store once in the RAM 34. Then, the processor 24 reads the image data from the RAM 34 and stores the data as an image file into a flash memory 32 while the meta information is associated therewith. At this time, the processor 24 makes a sound notifying that the main imaging process is performed to be output from the speaker not shown. In addition, in the flash memory 32, at least one folder is set, and an image file is saved in a folder that is set as a saving folder.

Furthermore, the camera function has a consecutive shooting function and a selection function. A consecutive shooting function means a function consecutively imaging a predetermined number (nine (9), for example) of images. The selection function is a function that an imaged image being in good condition is selected from the imaged images consecutively imaged by the consecutive shooting function on the basis of the face recognition rate, the focus evaluation value and so on.

In addition, the meta information of the camera function includes time information, an image size, a model name (type number) of the mobile phone 10, etc. The meta information related to the image data is saved in Exif format.

The I/F 46 is an interface for reading an image file, a music file or the like stored in the memory card 48. In the memory card 48, as similar to the flash memory 32, a folder is set, and when the main imaging process is performed, the image file may be saved in the folder of the memory card 48. Furthermore, the memory card 48 may be stored with address book data, etc. stored in the RAM 34 as back-up data.

The wireless communication circuit 14 is a circuit for performing a wireless communication with a CDMA system. For example, if the user designates a telephone dispatch (telephone call) using a key input device 26, the wireless communication circuit 14 performs a telephone call processing under instructions from the processor 24 and outputs a telephone call signal via the antenna 12. The telephone call signal is transmitted to a telephone at the other end of the line through a base station and a communication network (not shown). Then, an incoming processing is performed in the telephone at the other end of the line, a communication-capable state is established and the processor 24 starts the telephonic communication processing.

Describing specifically, a normal telephonic communication processing, a modulated sound signal sent from a telephone at the other end of the line is received by the antenna 12. The modulated sound signal received is subjected to a demodulation processing and a decode processing by the wireless communication circuit 14. A received sound signal obtained through such processing is converted into an analog sound signal by the D/A converter 20 to be output from the speaker 22. On the other hand, a sending sound signal taken-in through the microphone 18 is converted into a digital sound signal by the A/D converter 16 to be applied to the processor 24. The sending sound signal which is converted into the digital sound signal is subjected to an encode processing and a modulation processing by the wireless communication circuit 14 under instructions by the processor 24 to be output via the antenna 12. Therefore, the modulated sound signal is transmitted to the telephone at the other end of the line via the base station and the communication network.

When the telephone call signal from a telephone at the other end of the line is received by the antenna 12, the wireless communication circuit 14 notifies the processor 24 of the incoming call. In response thereto, the processor 24 displays on the display 30 sender information (telephone number and so on) described in the incoming call notification by controlling the display driver 28. In addition, at the approximately same time, the processor 24 outputs from the speaker a ringtone (may be also called as a ringtone melody, a ringtone voice).

Then, if the user performs a responding operation by using the call key, the wireless communication circuit 14 performs the incoming call processing under instructions by the processor 24. Furthermore, the communication-capable state is established, the processor 24 performs the above-described normal telephone communication processing.

If the telephone communication ending operation is performed by the end key after a state is changed to the communication-capable state, the processor 24 transmits the telephone communication ending signal to the telephone at the other end of the line by controlling the wireless communication circuit 14. Then, after the transmission of the telephone communication ending signal, the processor 24 terminates the telephone communication processing. Furthermore, in a case that the telephone ending signal from the telephone at the other end of the line is previously received, the processor 24 also terminates the telephone communication processing. In addition, in a case that the telephone communication ending signal is received from the mobile communication network not from the telephone at the other end of the line, the processor 24 also terminates the telephone communication processing.

In addition, in other embodiments, the wireless communication circuit 14, the A/D converter 16 and the D/A converter 20 may be incorporated within the processor 24. Furthermore, the flash memory 32 and the memory card 48 in each of which a folder is set may be collectively called as a storing portion.

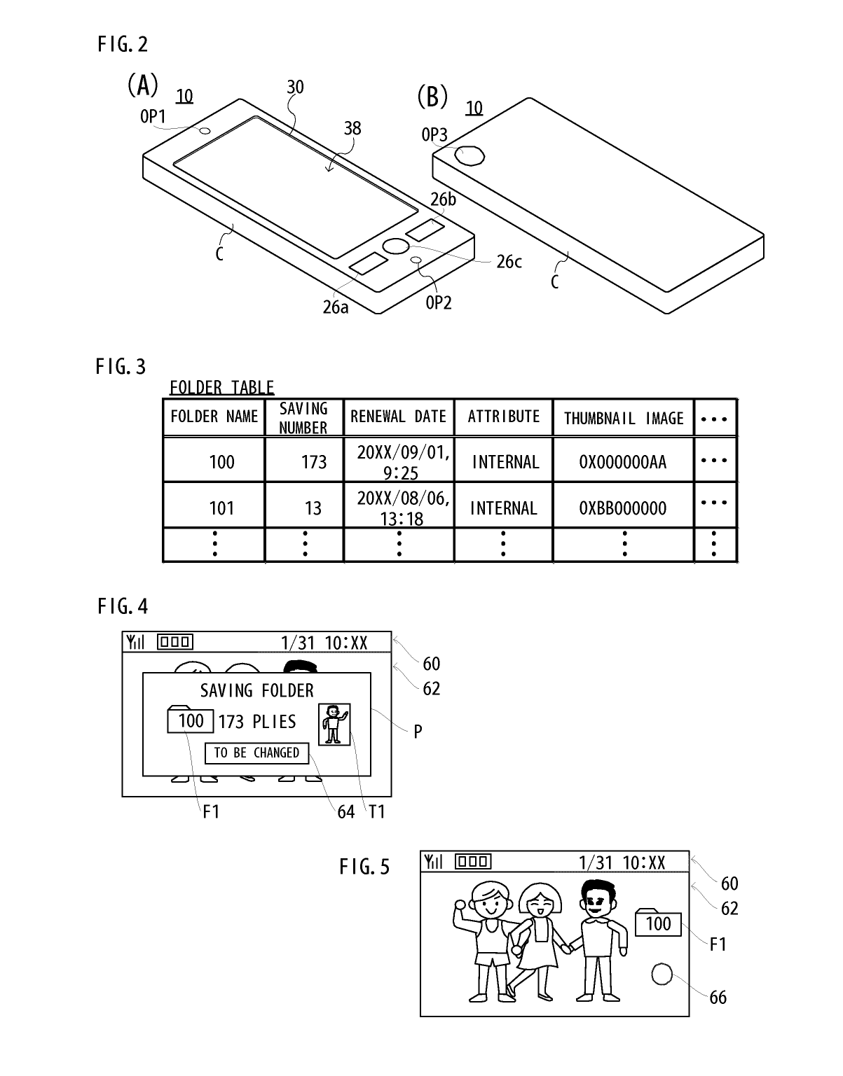

FIG. 2(A) is an appearance view showing an appearance of a top surface of the mobile phone 10, and FIG. 2(B) is an appearance view showing an appearance of a rear surface of the mobile phone 10. With referring to FIG. 2(A) and FIG. 2(B), the mobile phone 10 has a shape of straight-type and a housing C of a rectangular in plane. The microphone 18 not shown is housed within the housing C, and an opening OP2 communicated with the housed microphone 18 is provided on the surface at one end a longitudinal direction of the housing C. A speaker 22 is also housed within the housing C, and an opening OP1 communicated with the housed speaker 22 is provided on the surface at the other end in the longitudinal direction of the housing C. The display 30 is mounted in such a manner that a monitor screen can be seen from a top surface side. The display 30 is provided with the touch panel 38 thereon. An opening OP3 communicated with the camera module is provided at the upper left on the rear surface of the housing C. Then, the call key 26a, the end key 26b and the menu key 26c included in the key input device 26 are provided on the top surface of the housing C.

For example, the user inputs a telephone number by performing a touch operation onto the dial key displayed on the display 30, and by the call key 26a, performs a voice transmission operation. Then, if the telephone conversation is ended, the user performs the ending operation by the end key 26b. By operating the menu key 26c, the user can display the menu screen on the display 30. The user further performs a selection and decision of the menu by performing touch operations onto a soft key and a menu both displayed on the display 30. Then, by long-depressing the end key 26b, the user turns-on/-off a power of the mobile phone 10. Furthermore, the user can perform an imaging operation by directing the opening OP3 to an object during a time that the camera function is being performed.

In addition, the antenna 12, the wireless communication circuit 14, the A/D converter 16, the D/A converter 20, the processor 24, the display driver 28, the flash memory 32, the RAM 34, the touch panel control circuit 36, the camera module, the I/F 46 and the memory card 48 are housed within the housing C, and therefore, not shown in FIG. 2(A) and FIG. 2(B).

FIG. 3 is an illustrative view showing one example of structure of a folder table. In the folder table, information of folders formed in the flash memory 32 and the memory card 48 is recorded. Therefore, the folder table includes columns of “folder name”, “saving number”, “renewal date”, “attribute”, “thumbnail image”, etc.

In the column of “folder name”, folder names of the respective folders are recorded. In the column of “saving number”, the number of image files (plies) saved in the folder is recorded for each folder name. In the column of “renewal date”, for each folder, the date and time that the image file is lastly saved is recorded. In the column of “attribute”, in correspondence to the folder name, a character string representative of a storing portion in which the folder is set, that is, the flash memory 32 (internal) or the memory card 48 (external) is recorded. In the column of “thumbnail image”, for each folder name, a memory address showing a memory location in which an image file lastly saved is recorded is recorded. The memory address is read in producing a thumbnail image described later. Furthermore, the thumbnail image is produced based on the read image file, and as shown in FIG. 4 and so on, is displayed at a time that the content of the folder is to be displayed.

For example, with referring to a row that “100” is recorded in the column of “folder name”, “100” folder is formed within the flash memory (internal) 32, and the image files of 173 are saved therein. Furthermore, the date and time the image file is lastly saved with respect to “100” folder is “Sep. 1, 20XX, nine (9) o'clock twenty-five (25) minutes (20XX/09/01, 9:25)” and the image file lastly saved is recorded in the memory location shown by the memory address “0X000000AA”.

FIG. 4 is an illustrative view showing examples of a through image and a pop-up P both displayed on the display 30. With referring to FIG. 4, a display range of the display 30 includes a status displaying area 60 and a function displaying area 62. In the status displaying area 60, an icon (picto) representing a radiowave reception state by the antenna 12, an icon representing a residual battery capacity of a secondary battery and the date and time are displayed.

In the function displaying area 62, the through image is displayed, and the pop-up P is also displayed. In the pop-up P, a folder icon F1 indicating the saving folder, a thumbnail image T1 indicating an image file lastly saved into the saving folder and a character string indicating a number of the sheets (plies) saved in the saving folder (saving number) are included, and also a change key 64 is included. In addition, the change key 64 will be described later, and therefore, a detailed description thereof is omitted here.

A content displayed in the pop-up P is displayed based on the folder table shown in FIGS. 2(A) and 2(B). For example, in a case that “100” folder is set as a saving folder, from a row that the folder name is recorded as “100” in the folder table shown in FIGS. 2(A) and 2(B), the folder name of “100”, the saving number “173”, and the memory address of “0X000000AA” are read. Accordingly, in the pop-up P, the folder icon F1 written with “100” is displayed, “173” is displayed as the saving number, and a thumbnail image T1 corresponding to the image file which is read based on the above-described memory address is displayed.

With referring to FIG. 5, when a predetermined time period (five (5) seconds, for example) elapses from a time that the pop-up P is displayed, the displaying of the pop-up P is erased, and the displaying transits to a normal screen. If transited to the normal screen, a saving folder icon F1 representing the saving folder and a imaging key 66 are displayed at a right side portion of the function displaying area 62. That is, since the saving folder icon F is displayed together with the through image, in performing an imaging operation, conveniences or facilities can be increased.

In addition, the saving folder icon F corresponds to the same folder (here, “100” folder) as the folder icon F included in the pop-up P.

For example, if two fingers are slidden to be separated from each other after the multi-touch operation is performed within the function displaying area 62, the through image is zoomed-up. Inversely, two fingers are slidden to be closed to each other, the through image is zoomed-down.

Then, if the touch operation is made to the imaging key 66, the main imaging process is performed, an image file produced based on the imaged image is saved in “100” folder corresponding to the saving folder icon F1.

Here, in this embodiment shown, if the touch operation against the change key 64 included in the pop-up P or the saving folder icon F1 in a state that the through image is being displayed, the displaying is changed to the selection screen. In the selection screen, the folder icons respectively corresponding to the folders set in the storing portion are simultaneously displayed in the function displaying area 62. Therefore, the user can easily change a folder that an image file based on an imaged image is to be saved by performing a touch operation to a folder icon F being simultaneously displayed.

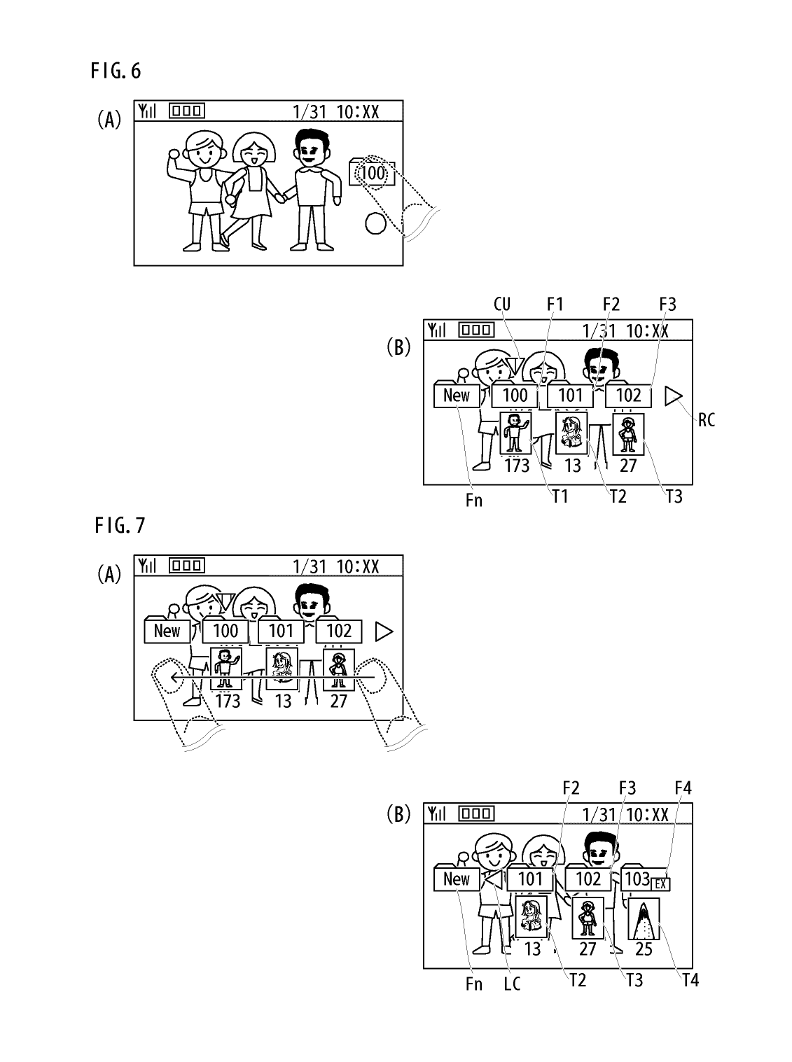

For example, with referring to FIG. 6(A) and FIG. 6(B), if the touch operation is made to the saving folder icon F1 that is also called as a changing icon, folder icons F1-F3 respectively corresponding to the folders set in the storing portion are displayed in a selectable manner in the function displaying area 62.

In the respective folder icons F1-F3, on the basis of the folder table, the thumbnail images T1-T3 and the saving numbers are displayed while being associated with each other. Furthermore, the cursor CU representing that the folder is set as the saving folder is displayed in association with the folder icon F1. At a right side of the folder icons F, a right cursor RC representing that there is a folder icon F not being displayed is displayed in a right side portion of the displaying range. At a left side of the folder icons F, a new folder icon Fn described later is displayed.

Thus, the folder icons F are simultaneously displayed from a timing that the saving folder icon F is operated, and therefore, the visibility of the through image in the normal screen is increased. For example, if the folder icons F are always displayed, displaying contents in the function displaying area 62 are increased and complex, and therefore, the visibility of the through image is lowered. In contrast, as done in this embodiment, the folder icons F are simultaneously displayed at a time that the displaying is changed to the selection screen from the normal screen, it is possible to increase the visibility of the through image in the normal screen. However, in other embodiments, in order to cope both with the convenience or facility of the user and the visibility of the through image, the folder icons F and so on may be displayed in a lower portion (or upper portion) of the function displaying area 62 while the displaying sizes of the folder icons F and so on are reduced.

In addition, in other embodiments, instead of the saving folder icon F, a dedicated icon (change icon) may be displayed in the function displaying area 62.

With referring to FIG. 7(A) and FIG. 7(B), if the slide operation in the left direction is made in a state that the right cursor RC is being displayed, a folder icon F not having been displayed becomes to be displayed. That is, in a state of FIG. 7(A), if the slide operation in the left direction is performed, a folder icon F4 not having been displayed becomes to be displayed in the function displaying area 62.

If the folder icon F4 is displayed, a thumbnail image T4 and a saving number (25) each corresponding to the folder icon F4 are also displayed. Since the number of the folder icons F capable of being displayed in the function displaying area 62 is three (3) at maximum, the folder icon F1 displayed at the left side, the thumbnail image T1, the saving number and the cursor CU which were displayed in association with the folder icon F1 become not to be displayed. Then, instead of the folder icon F1, a left cursor LC representing that a folder icon F1 exists is displayed at a left outside the displaying range.

Furthermore, since the folder icon F4 is a folder set in the memory card 48, an auxiliary icon representing that the folder is set in the memory card 48 (external memory) is added to the icon.

If the slide operation in the right direction is performed in a state that the left cursor LC is being displayed, the displaying of the folder icons F returns to a state of FIG. 6(B). In other embodiments, a folder icon F which exists outside the displaying range may be displayed if and when the touch operation is made to the right cursor RC or the left cursor LC.

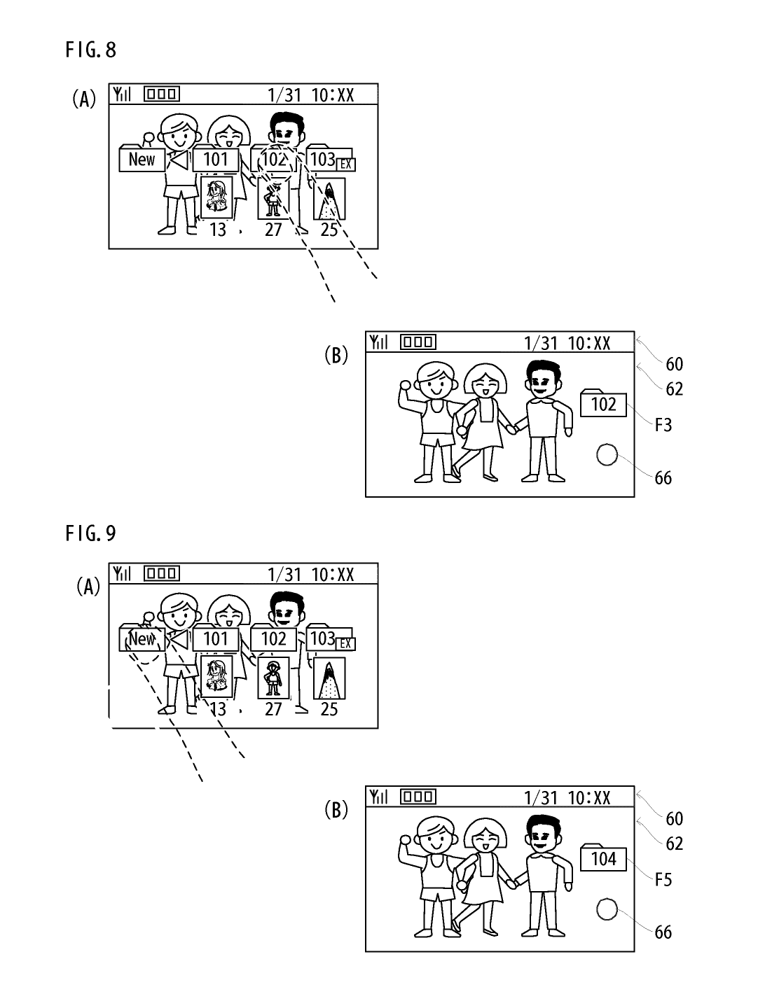

Then, if the touch operation is performed against an arbitrary folder icon F, a folder corresponding to the folder icon F selected (designated) through such the touch operation is set as a saving icon. With referring to FIG. 8(A) and FIG. 8(B), if the touch operation is performed to the folder icon F3, “102” folder corresponding to the folder icon F3 is set as a saving folder. Consequently, the screen is changed from the selection screen to the normal screen and the saving folder icon F3 corresponding to “102” folder that is set as the saving folder and the imaging key 66 are displayed in a right side portion of the function displaying area 62.

Thus, it is possible for the user to set such that the imaged image is saved in an arbitrary folder while seeing the through image. Therefore, the operability at a time of the imaging increases. Especially, the user can see the through image and the thumbnail image T, and therefore, the folder to be set as a saving folder becomes to be specified easily.

With referring to FIG. 9(A) and FIG. 9(B), if the touch operation is made to the new folder icon Fn, a new folder is formed. That is, a row corresponding to the new folder is added into the folder table. Then, the formed new folder is set as a saving folder. For example, in a case that the touch operation is made onto the new folder icon Fn and thus “104” folder is formed as a new folder, if the screen is changed from the selection screen to the normal screen, the folder icons F being displayed simultaneously are erased, and a saving folder icon F5 corresponding to “104” folder being set as a saving folder and the imaging key 66 are displayed in the function displaying area 62.

Thus, even if a necessary folder has not been set in the storing portion, the user can produce a new folder and save the imaged image into the new folder. Especially, in a case that the user cannot find a folder to be set as a saving folder based on the thumbnail image or in a case that the saving number in a folder that is to be set as a saving folder is too large, the user can produce a new folder.

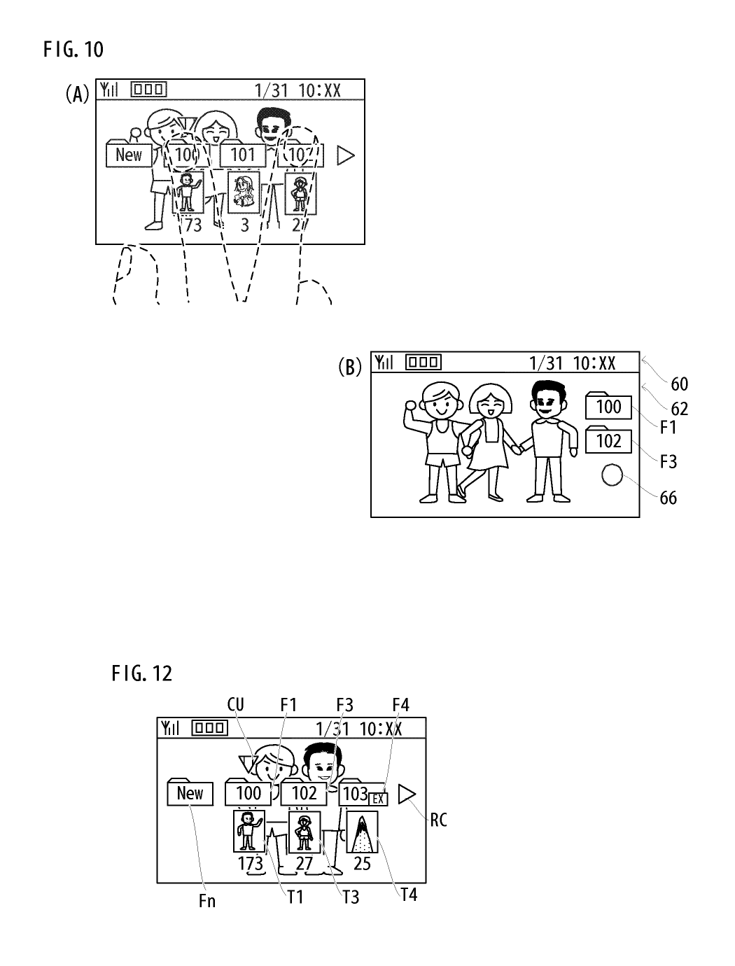

With referring to FIG. 10(A) and FIG. 10(B), if the multi-touch operation is made to a plurality of folders, the plurality of folders are set as saving folders. For example, if the multi-touch operation is made to the folder icon F1 and the folder icon F3, “100” folder and “102” folder respectively corresponding to the folder icons F1 and F3 are set as saving folders, respectively. Therefore, if the screen returns from the selection screen to the normal screen, the saving folder icons F1 and F3 corresponding to the “100” folder and “102” folder and the imaging key 66 are displayed in the function displaying area 62. Then, if the imaging key 66 is operated in that state to perform a main imaging process, the same imaged image is saved in both “100” folder and “102” folder. Thus, since a plurality of saving folders can be set prior to the imaging operation, it is possible to omit a troublesome operation such that the imaged image is copied to another folder after the imaging operation.

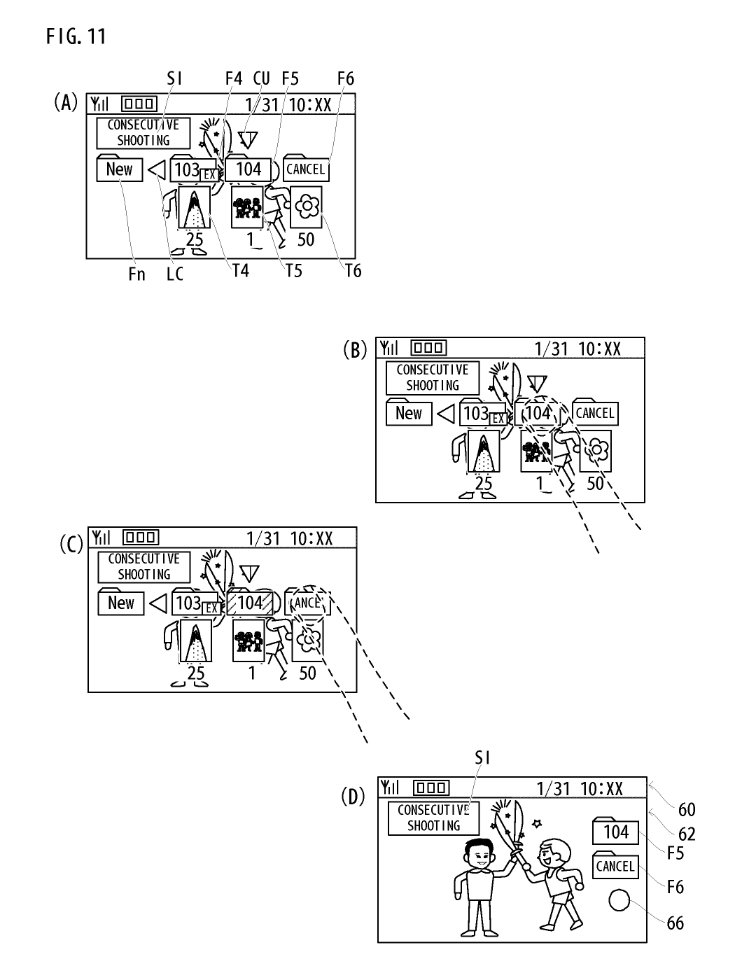

With referring to FIG. 11(A), if a consecutive shooting function of the camera function is made effective, a consecutive shooting icon SI is displayed in the function displaying area 62. Then, in a case that the consecutive shooting function is made effective, it is possible to set a first consecutive shooting folder into which an imaged image selected by a selecting function is saved and a second consecutive shooting folder into which an imaged image not being selected is saved.

In addition, in FIG. 11(A)-FIG. 11(C), only for explanation, a folder icon F6 corresponding to “cancel” folder that is newly set by the user and the thumbnail image T6 and the saving number associated with the folder icon F6 are further displayed.

With referring to FIG. 11(B) and FIG. 11(C), for example, the touch operation is made to the folder icon F5 at a time that the folder icons F are being simultaneously displayed, the folder corresponding to the folder icon F5 is set as a first consecutive shooting folder, and a color of the folder icon F5 is changed. That is, by changing the color of the folder icon, it is indicated that the folder icon F5 is set as the first consecutive shooting folder. Subsequently, if the touch operation is made to the folder icon F6, the folder corresponding to the folder icon F6 is set as a second consecutive shooting folder, and then, the screen returns to the normal screen.

Then, with referring to FIG. 11(D), at a right side portion of the function displaying area 62, the folder icon F5 corresponding to the “104” folder that is set as the first consecutive shooting folder, the folder icon F6 corresponding to “cancel” folder that is set as the second consecutive shooting folder and the imaging key 66 are displayed, and the consecutive shooting icon SI is further displayed at the upper left.

In such a state, if the touch operation is made onto the imaging key 66, a predetermined number of images are consecutively imaged, the imaged image in good condition is saved in “104” folder being set as the first consecutive shooting folder, and other imaged image is saved in “cancel” folder being set as the second consecutive shooting folder. That is, it becomes unnecessary to make an operate that unnecessary image is transferred to a separate folder after the consecutive shooting. In addition, an imaged image not selected can be confirmed by opening “cancel” folder being set as the second consecutive shooting folder. The image file saved in “cancel” folder may be automatically deleted after a predetermined time period elapses.

Next, if the double-touch operation is made in the function displaying area 62 at a time that the folder icons F are simultaneously displayed, an alignment order of the folder icons F is changed. For example, in an initial state, folder icons F in the selection screen are aligned in an order of a folder name. In such a state, if the double-touch operation is made, as shown in FIG. 12, the folder icons F are rearranged such that the folder icons are aligned in an order of the saving number. Furthermore, in FIG. 12, although folder icons F are aligned in an order of larger saving number, it is possible to rearrange in an order of smaller saving number by performing the slide operation in the up and down direction.

Furthermore, the alignment of the folder icons F is changed at every double-touch operation in an order of the renewal date and then in an order of attribute. Then, if the double-touch operation is made at a time that the folder icons are aligned in the order of attribute, the alignment returns to in an order of the folder name.

Thus, since it is possible to change an alignment order of the folder icons F, it is possible for the user to easily search a necessary folder icon. However, in a case that a mobile phone 10 is comprised with an acceleration sensor in other embodiments, the alignment of the folder icons F may be returned to the initial state (in the order of the folder name) by performing an operation that the mobile phone 10 is shaken.

Although not shown, even in a case that the change key 64 included in the pop-up P which is displayed at a time that the camera function is activated, the folder icons F are simultaneously displayed as shown in FIG. 6(B). That is, the user can change the setting of the saving folder at a time that the camera function is performed.

In a state that the folder icons F are being simultaneously displayed, if the touch-release operation is made onto a region that the icon and the thumbnail image T are not being displayed, the setting of the saving folder is not changed, and the alignment of the folder icons is erased.

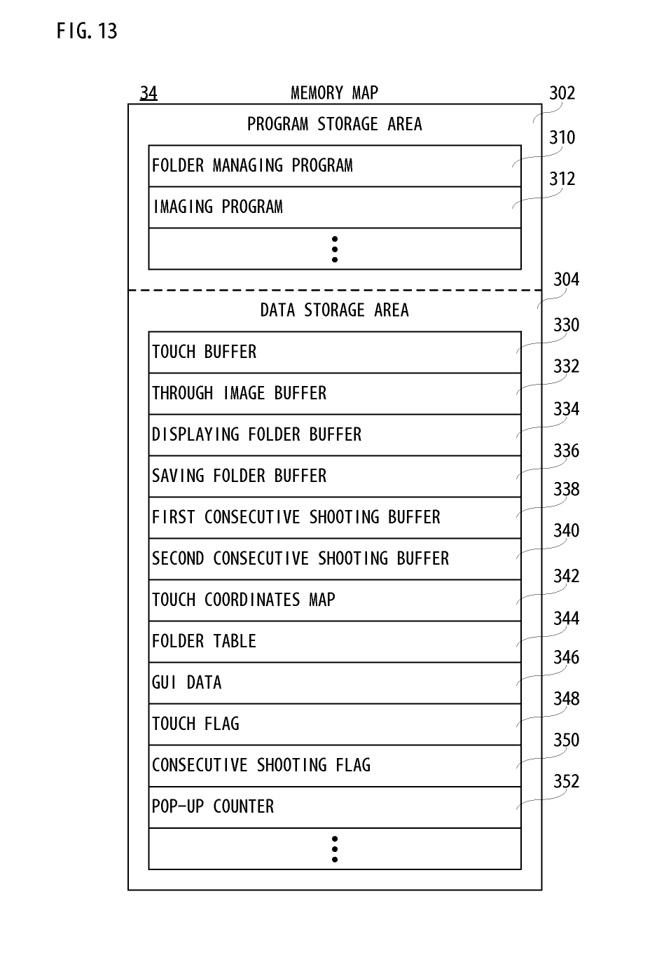

FIG. 13 is a view showing a memory map of the RAM 34. The RAM 34 includes a program storage area 302 and a data storage area 304. In addition, the program and data are read-out wholly at once or partly and sequentially read out as necessary from the flash memory 32 to be stored in the RAM 34.

In the program storage area 302, programs for operating the mobile phone 10 are stored. For example, the program for operating the mobile phone 10 includes a folder managing program 310, an imaging program 312, etc.

The folder managing program 310 is a program for changing a setting of a saving folder. The imaging program 312 is a program for imaging an image according to an imaging operation and for saving an image file based on an imaged image.

Although not shown, the program for operating the mobile phone 10 further includes a program for establishing a communication-capable state, etc.

Next, in the data storage area 304, a touch buffer 330, a through image buffer 332, a displaying folder buffer 334, a saving folder buffer 336, a first consecutive shooting folder buffer 338, a second consecutive shooting folder buffer 340 and so on are provided, and touch coordinates map 342, folder table 344 and GUI data 346 are also stored. Furthermore, in the data storage area 304, a touch flag 348, a consecutive shooting flag 350 and a pop-up counter 352 are also provided.

The touch buffer 330 is temporarily stored with coordinates of a touch point, a touch position and a release point that are output from the touch panel control circuit 36. In the through image buffer 332, image data of a YUV format is temporarily stored. The displaying folder buffer 334 is stored with a folder name corresponding to a folder icon F displayed in the function displaying area 62, etc. In the saving folder buffer 336, a folder name set as a saving folder, etc. are temporarily stored. In the first consecutive shooting folder buffer 338 and the second consecutive shooting folder buffer 340, folder names set as the first consecutive shooting folder and the second consecutive shooting folder are temporarily stored.

The touch coordinates map 342 is data for mapping touch coordinates of the touch operation and displaying coordinates of the display 30 with each other. That is, based on the touch coordinates map 342, a result of the touch operation performed against the touch panel 38 is mapped onto a displaying of the display 30.

The folder table 344 is data corresponding to the folder table of the structure shown in FIG. 3, for example. The GUI data 346 is data which includes images and character strings for displaying the pop-up P, the folder icons F and so on.

The touch flag 348 is a flag for determining whether or not the touch operation is made to the touch panel 38. The touch flag 348 is formed by a 1-bit register, for example. If the touch flag 348 is turned-on, a data value “1” is set in the register. On the other hand, if the touch flag 348 is turned-off, a data value “0” is set in the register.

The consecutive shooting flag 350 is a flag for determining whether or not the consecutive shooting function is made effective. In addition, since the structure of the consecutive shooting flag 350 is the same as that of the touch flag 348, a detailed description thereof will be omitted here.

The pop-up counter 352 is a counter for measuring a time that the pop-up P is displayed, and in response to a reset thereof, a count (measurement) is started. Therefore, the pop-up counter 352 is also called as a pop-up timer.

Although not shown, the data storage area 304 further stores an image data displayed on the display 30 in a standby state, data of character string, etc., and is provided with counters and flags necessary for the operation of the mobile phone 10.

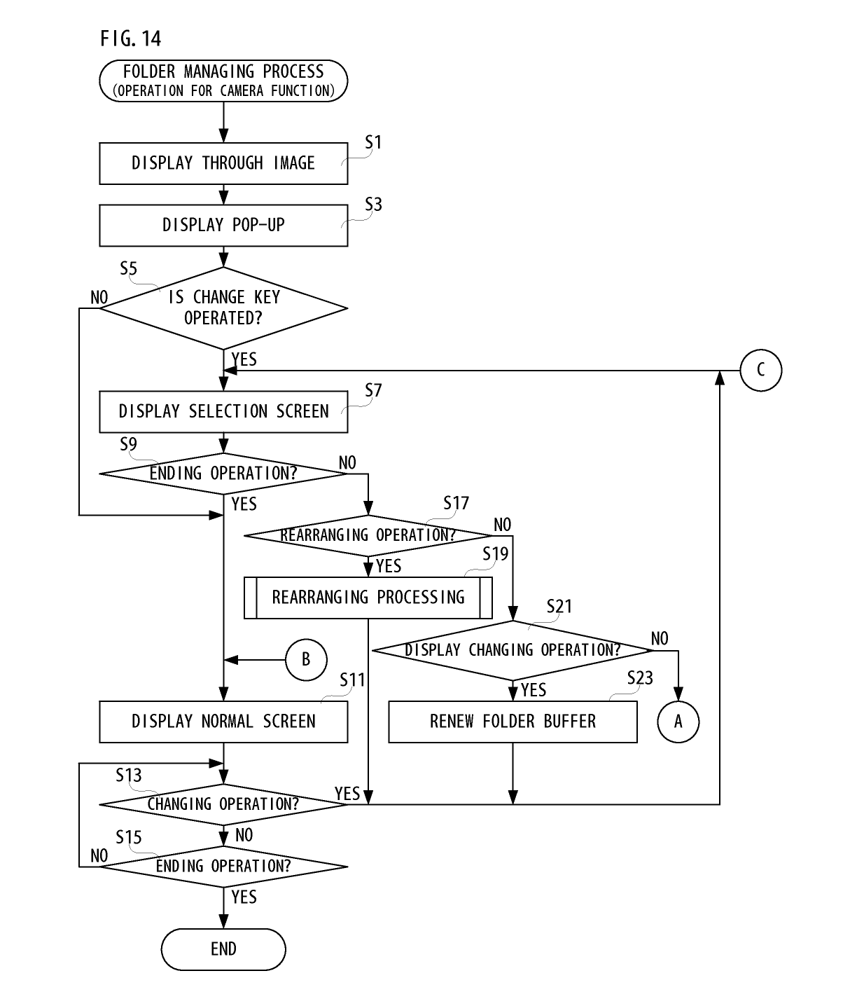

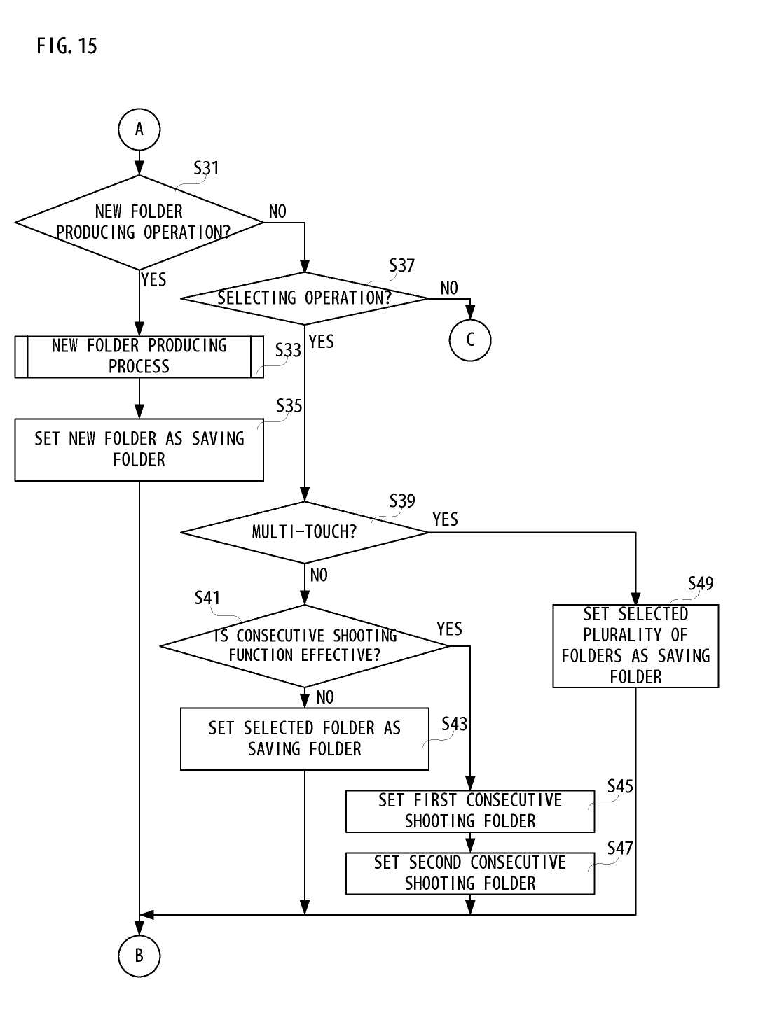

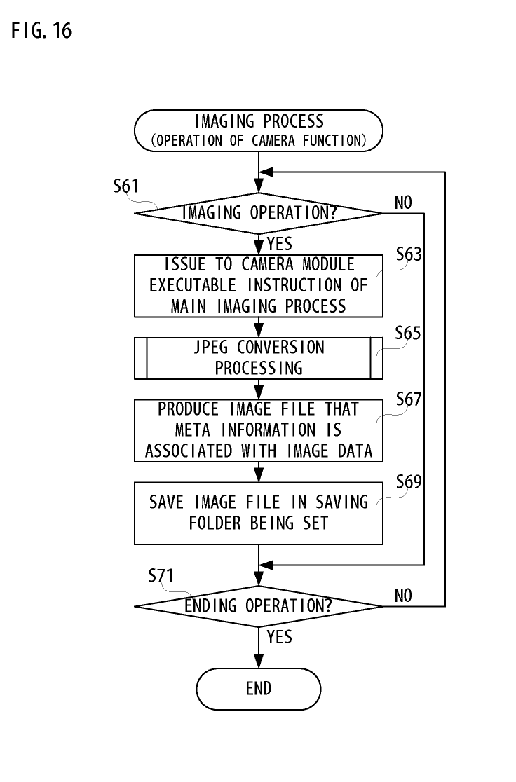

The processor 24 processes a plurality of tasks including a folder managing process shown in FIG. 14 and FIG. 15, an imaging process shown in FIG. 16, etc., in parallel with each other under controls of Linux (registered trademark)-base OS such as Android (registered trademark) and REX, or other OSs.

FIG. 14 is a flowchart showing a part of an operation of the folder managing process. For example, when an operation for performing the camera function is made, in a step S1, the processor 24 displays a through image. That is, the processor 24 issues a thinning read instruction for thinning-reading image data of a YUV format being stored in the through image buffer 322 to the display driver 28. In addition, the processor 24 executing a processing of the step S1 functions as a displaying processing portion.

Subsequently, in a step S3, a pop-up P is displayed. That is, the information of the saving folder is read from the folder table 344 based on the saving folder buffer 336 so as to display the pop-up P in the function displaying area 62. Then, in the pop-up P is displayed, the pop-up timer is initialized. In addition, the processor 24 executing a processing in the step S3 functions as a pop-up displaying processing portion.

In a step S5, it is determined whether or not the change key 64 is operated. That is, it is determined whether or not the touch operation to the change key 64 shown in FIG. 4 is performed. If “YES” is determined in the step S5, that is, if the touch operation is made onto the change key 64, in a step S7, a selection screen is displayed. That is, folder icons F to be displayed are decided on the basis of the folder table 344, and folder names are stored in the displaying folder buffer 336. Then, the processor 24 displays an alignment of folder icons F based on the displaying folder buffer 336, and further displays a new folder icon Fn and a cursor CU. At this time, a displaying position of the cursor CU is decided based on the folder names stored in the saving folder buffer 336. In addition, the processor 24 executing the processing in the step S7 functions as an icon displaying processing portion.

Subsequently, in a step S9, it is determined whether or not an ending operation is performed. That is, it is determined whether or not an ending operation for ending the displaying of the selection screen is made. More specifically, as described above, it is determined whether or not a touch-release operation is performed onto a position that the folder icon F, etc. are not being displayed. If “YES” is determined in the step S9, that is, if the above-described ending operation is performed, the normal screen is displayed in a step S11. That is, instead of the aligned displaying of the folder icons F, as shown in FIG. 5, the change icon (saving folder icon F) and the imaging key 66 are displayed. In addition, in a case that “NO” is determined in the step S5, that is, if the predetermined time period is measured by the pop-up timer with no operation of the change key 64, the normal screen is also displayed in the step S11. The processor 24 executing the processing in the step S11 functions as a change icon displaying processing portion.

Furthermore, in a step S13, it is determined whether or not the changing operation is performed. That is, it is determined whether or not the touch operation is made onto the saving folder icon F1 as shown in FIGS. 6(A) and 6(B). If “NO” is determined in the step S13, that is, if the above-described changing operation is not performed, it is determined whether or not the ending operation is performed in a step S15. That is, it is determined whether or not the ending operation of the camera function is made. If “YES” is determined in the step S15, that is, if the ending operation of the camera function is performed, the folder managing process is terminated.

In addition, if “NO” is determined in the step S15, the process returns to the step S13. If “YES” is determined in the step S13, that is, if the changing operation is made, the processing in the step S7 and S9 are performed again.

If “NO” is determined in the step S9, that is, if the touch-release operation is not made in a state that the folder icons F are being simultaneously displayed, it is determined in a step S17 whether or not a rearranging operation is performed. That is, it is determined whether or not the double-touch operation is made in the function displaying area 62. If “YES” is determined in the step S17, that is, if the double-touch operation is made, the rearrangement processing is performed in a step S19, and then, the process returns to the step S7. For example, in a case that the folder icons F are aligned in an order of the folder name, the folder icons F are rearranged such that the folder icons F are aligned in an order of the saving number as shown in FIG. 12. In addition, the processor 24 executing the processing in the step S19 functions as rearranging portion.

If “NO” is determined in the step S17, that is, if the above-described rearranging operation is not performed, it is determined whether or not the display changing operation is performed in a step S21. That is, it is determined whether or not the slide operation in the left direction or in the right direction is performed in a state that the left cursor LC or the right cursor RC is being displayed. If “YES” is determined in the step S21, for example, if the slide operation in the left direction is performed as shown in FIG. 7(A), the displaying folder is renewed in a step S23, and then, the process returns to the step S7. For example, in a case that the slide operation in the left direction is performed as shown in FIG. 7(A), the folder names of “101” folder, “102” folder and “103” folder are recorded in the displaying folder buffer 334. In addition, if “NO” is determined in the step S21, that is, if the above-described display changing operation is not performed, the process proceeds to a step S31.

With referring to FIG. 15, the processor 24 determines in a step S31 whether or not a new folder producing operation is performed in a step S33. If “YES” is determined in the step S31, a new folder producing processing is performed. That is, a memory area in the flash memory 32 is reserved, and information of the new folder is registered in the folder table 344. The processor 24 executing the processing in the step S33 functions as a producing portion.

Next, in a step S35, a new folder is set as a saving folder. For example, in a case that “104” folder is produced as a new folder, the folder name of “104” folder is recorded in the saving folder buffer 336. Then, the process returns to the step S11 in FIG. 14 after the processing of the step S35 is terminated.

If “NO” is determined in the step S31, that is, the new folder producing operation is not made, in a step S37, it is determined whether or not a selecting operation is performed. That is, it is determined whether or not the touch operation is made to at least one of the folder icons F being simultaneously displayed. If “NO” is determined in the step S37, that is, if the touch operation is not made in a state that the selection screen is being displayed, the process returns to the step S7 of FIG. 14.

Furthermore, if “YES” is determined in the step S37, that is, the touch operation is made onto the folder icon F, in a step S39, it is determined whether or not the multi-touch operation is made. That is, it is determined whether or not two folder icons F are touched at the same time or at approximately the same time. If “NO” is determined in the step S39, that is, if the touch operation is made onto one folder icon, in a step S41, it is determined whether or not the consecutive shooting function is made effective. That is, it is determined whether or not the consecutive shooting flag 350 is turned-on. If “NO” is determined in the step S41, that is, if the consecutive shooting flag 350 is turned-off, in a step S43, a selected folder is set as a saving folder, and then the process returns to the step S11 in FIG. 14. For example, as shown in FIG. 8(A), the touch operation is made against the folder icon F3, the folder name of “102” folder corresponding to the folder icon F3 is recorded in the saving folder buffer 336.

If “YES” is determined in the step S41, that is, if the consecutive shooting function is made effective, in a step S45, a first consecutive shooting folder is set. For example, as shown in FIG. 11(B), if the touch operation is made onto a first folder icon F5, the folder name of “104” folder corresponding to the folder icon F5 is recorded in the first consecutive shooting folder buffer 338. In addition, when the processing in the step S45 is ended, the color of the folder icon F to which the touch operation is made is changed.

Subsequently, in a step S47, a second consecutive shooting folder is set, and then, the process returns to the step S11 shown in FIG. 14. At first, in the step S47, it is determined whether or not the touch operation is made onto a second folder icon F. For example, as shown in FIG. 11(C), if the touch operation is made onto a second folder icon F6, the folder name of “cancel” folder corresponding to the folder icon F6 is recorded in the second consecutive shooting folder buffer 340. In addition, the processor 24 performing the processing in the steps S45 and S47 functions as a consecutive shooting folder setting portion.

If “YES” is determined in the step S39, that is, if the multi-touch operation is made onto two folder icons F, in a step S49, the selected plurality of folders are set as saving folders, and then, the process returns to the step S11 in FIG. 14. For example, as shown in FIG. 10(A), the multi-touch operation is made onto the folder icon F1 and the folder icon F3, the folder names of “100” and “102” folder respectively corresponding to the folder icons F1 and F3 are recorded in the saving folder buffer 336.

In addition, in the folder managing process, the processor 24 executing the processing in the steps S35, S43-S49 functions as a setting portion.

FIG. 16 is a flowchart of an imaging process. For example, if an operation for executing the camera function is performed, in a step S61, the processor 24 determines whether or not an imaging operation is performed. That is, it is determined whether or not the touch operation is made onto the imaging key 66. If “NO” is determined in the step S61, the process proceeds to a step S71. On the other hand, if “YES” is determined in the step S61, that is, if the touch operation to the imaging key 66 is performed, the processor 24 issues an executable instruction of the main imaging process to the camera module in a step S63. Subsequently, in a step S65, a JPEG conversion processing is performed. That is, image data of YUV format output from the camera module is converted (compressed) into image data of JPEG format. Next, in a step S67, an image file is produced while the meta information is made to be associated with the image data. In a step S69, the image file is saved in a saving folder being set. That is, the saving folder is specified based on the folder name recorded in the saving folder buffer 336, and the produced image file is saved in the specified saving folder. In addition, the processor 24 executing the processing in the step S69 functions as a saving portion.

Next, in the step S71, it is determined whether or not an ending operation is made. That is, as similar to the step S15 of the folder managing process, it is determined whether or not an ending operation for the camera function is performed. If “NO” is determined in the step S71, that is, the ending operation of the camera function is not performed, the process returns to the step S61. If “YES” is determined in the step S71, that is, if the ending operation for the camera function is performed, the imaging process is terminated.

### Second Embodiment

In s second embodiment, a screen is changed to a selection screen and the setting of the saving folder is changed by utilizing specifying regions SA set within the touch range of the touch panel 38 instead of the folder icons F. In the following, although the second embodiment is described, the second embodiment is the same as the first embodiment except these points, and therefore, a duplicate description will be omitted.

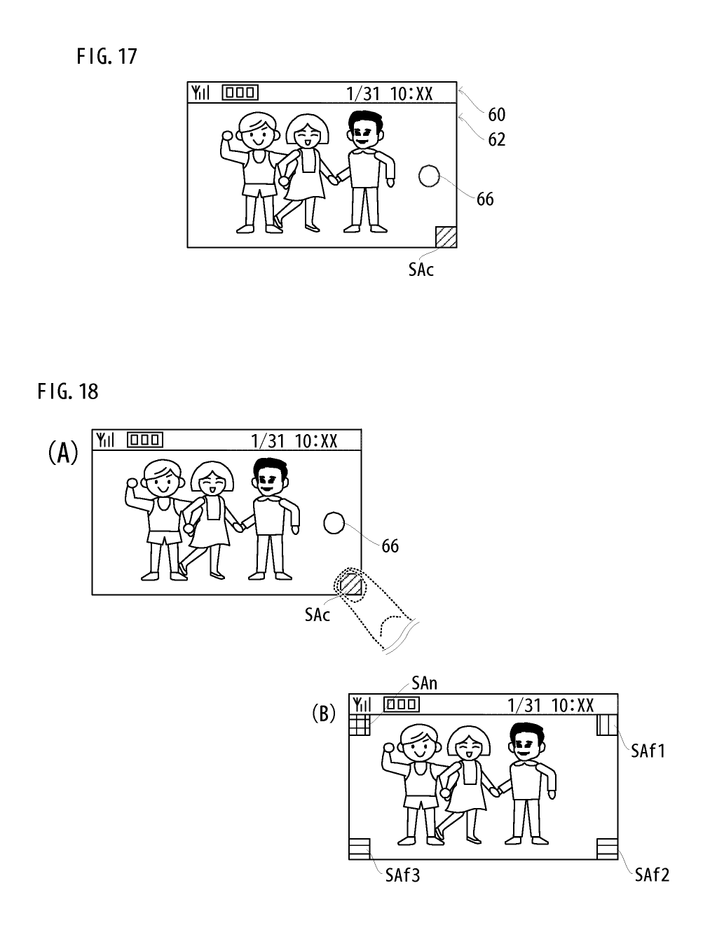

With referring to the FIG. 17, in a normal screen, instead of the saving folder icon F, a change specifying region SAc in a blue color (in the drawing, slant lines) is formed. Then, as similar to the first embodiment, if and when the touch operation is made to the change specifying region SAc, the screen is changed to the selection screen.

With referring to FIG. 18(A) and FIG. 18(B), if the touch operation is made onto the change specifying region SAc, folder specifying regions SAf1, SAf2 and SAf3 respectively corresponding to the folders being set in the storing portion are set at a upper right corner, a lower right corner and a lower left corner of a touch range corresponding to the function displaying area 62. Then, at an upper left corner of the touch range corresponding to the function displaying area 62, a new folder specifying region SAn is set.

Folder specifying regions SAf are colored with colors different from each other for each corresponding folder. For example, the folder specifying region SAf1 corresponding to the saving folder is colored in a green color (in the drawings, vertical lines), the folder specifying regions SAf2 and SAf3 corresponding to other folders are colored in a yellow color (in the drawings, horizontal lines). Then, a new folder specifying region SAn is colored in a red color (in the drawings, mesh patterns). Accordingly, the user can easily identify the folder corresponding to the folder specifying region SAf and the new folder specifying region SAn.

As similar to the first embodiment, if the touch operation is made onto an arbitrary one of the folder specifying regions SAf1-SAf3, the folder corresponding to the folder specifying region SAf to which the touch operation is made is set as a saving folder. Furthermore, if the touch operation is made onto the new folder specifying region SAn, a new folder is produced, and a row corresponding to the new folder is added into the folder table.

Thus, in the second embodiment, the user can set that the imaged image is saved in an arbitrary folder while seeing the through image, and therefore, operability at a time of the imaging increases.

However, in other embodiments, the specifying regions SA may be provided at positions other than corners of the touch range. Furthermore, in other embodiments, the specifying regions SA may not be colored. For example, as shown in FIG. 18(B), in a case that the specifying region SA is set at a position easy to find such as a corner of the touch range, the user can grasp the position even if the user cannot see the specifying region SA. Therefore, there is no problem even if the specifying region SA is not colored.

Although a specific description of the folder managing process in the second embodiment will be omitted, if the processing in the step S7 is performed, the folder specifying region SAf and the new folder specifying region SAn are set in the touch range corresponding to the function displaying area 62. Furthermore, if either processing in the steps S35 and S43-S49 is performed, the folder corresponding to the folder specifying region SAf to which the touch operation is made is set as a saving folder. Therefore, in the second embodiment, the processor 24 executing the processing of the step S7 functions as a region setting portion, and the processor 24 executing the processing of the steps S35 and S43-S49 functions as a saving folder setting portion.

In addition, the first embodiment and the second embodiment can be arbitrarily combined with each other, but because a specific combination can be easily assumed, a detailed description is omitted.

Furthermore, the number of the folder icons F or the folder specifying regions SAf displayed in the selection screen is not limited to three (3), and may be four (4) or more, or one (1) or two (2).

Furthermore, in a case that the double-touch operation is made to the folder icon F or the folder specifying region SAf, the image saved in that folder may be displayed.

In addition, the folder name can be arbitrarily edited by the user. Furthermore, the thumbnail image T and the saving number may be displayed in association with the saving folder icon F.

In other embodiments, an image sensor 42 in which photo-receiving elements corresponding to SXGA (1280×1024 pixels) are arranged may be adopted. Furthermore, the user can change a size of the image data to a size for XGA (1024×768 pixels), VGA (640×480 pixels) or the like other than the size of UXGA or SXGA.

Furthermore, the new folder may be produced in the memory card 48 not in the flash memory 32. For example, if the size of the image data is more than the size of XGA, a new folder is produced in the memory card 48. If the size of the image data is less than the size of XGA, a new folder is formed in the flash memory 32.

In other embodiments, instead a folder icon shown in FIG. 4, an icon having other design may be adopted. Furthermore, in other embodiments, instead a folder icon, an image icon utilizing a thumbnail image or a transparent icon through which a through image can be seen may be adopted.

In other embodiments, in a case that an imaged image is pre-viewed after the imaging operation and the user must input whether the imaged image is to be saved or not, during such a preview displaying, as similar to the above-described embodiments, the folder to which the image file is saved may be changed.

Furthermore, a communication system of the mobile phone 10 in the embodiments is a CDMA system, but an LTE system, a W-CDMA system, a GSM system, a TDMA system, a FDMA system, a PHS system or the like may be adopted. Furthermore, as the display 30, an LCD monitor is utilized, but an organic EL panel or the like may be adopted. The appearance of the mobile phone 10 may be a straight-type, a slide-type, a one-axis or two-axis foldable type.

A plurality of programs utilized in the above-described embodiments may be stored in a HDD of the server for data distribution, and distributed to the mobile phone 10 via the network. The plurality of programs may be stored in a storage medium such as an optical disk of CD, DVD, BD (Blu-ray Disc) or the like, a USB memory, a memory card, etc. and then, such the storage medium may be sold or distributed. In a case that the plurality of programs downloaded via the above-described server or storage medium are installed to a mobile phone having the structure equal to the structure of the embodiment, it is possible to obtain advantages equal to advantages according to the embodiment.

Furthermore, the above-described embodiments may be adapted not only to the mobile phone 10 but also so-called a smartphone, an electronic book terminal, a tablet PC, a PDA and so on.

The specific numerical value mentioned in this specification are only examples, and changeable properly in accordance with the change of product specifications.

The embodiment is a mobile terminal which includes a camera module and a display portion displaying an image that the camera module outputs, and performs a camera function, comprising: a storing portion in which at least a folder is set; a displaying processing portion which displays a through image on the display portion based on an output of the camera module; an icon displaying processing portion which displays an icon corresponding to the folder in a selectable manner at a time that the through image is being displayed by the displaying processing portion; a setting portion which sets a folder corresponding to a selected icon as a saving folder in which an imaged image is saved; and a saving portion which saves an imaged image in the saving folder that is set by the setting portion when an imaging operation is performed.

In the present embodiment, a mobile terminal (10: a reference numeral exemplifying a corresponding portion in the embodiment, and so forth) comprises a camera module including a camera control circuit (40) and an image sensor (42) and a focus lens (44), and capable of performing a camera function that an imaging can be performed in response to an operation by a user. If the camera function is performed, in a displaying portion (30), an image that the camera module outputs is displayed. A storing portion includes a flash memory (32) and a memory card (48) in which at least a folder is set. A displaying processing portion (24, S1) displays a through image on a display portion based on the output of the camera module. An icon displaying processing portion (24, S7) displays an icon (F1-F6) corresponding to the folder in the storing portion on the through image in a superposed manner. A setting portion (24, S35, S43-S49) sets, if an icon is selected through a touch operation, for example, a folder corresponding to the icon as a saving folder in which an imaged image is saved. A saving portion (24, S69) saves an imaged image in the set saving folder if and when an imaging operation is performed.

According to the embodiment, the user can set such that the imaged image is saved in an arbitrary folder while seeing the through image, and therefore, operability at a time of the imaging operation is increased.

Another embodiment is a mobile terminal wherein the icon displaying processing portion displays a new icon corresponding to a new folder, further comprising a producing portion which produces a new folder in the storing portion if and when an operation to the new icon is performed, wherein the setting portion sets the new folder as a saving folder at a time that the new folder is produced by the producing portion.

In this embodiments, the icon displaying processing portion displays a new icon (Fn) corresponding to a new folder in a portion adjacent to icons being simultaneously displayed. The producing portion (24, S33) produces a new folder in the storing portion if and when the new icon is operated. Then, the setting portion sets the new folder as a saving folder if the new folder is produced.

According to the embodiment, even if a necessary folder is not set in the storing portion, the user can produce a new folder and save the imaged image in the new folder.

A further embodiment further comprises a change icon displaying processing portion that displays a change icon for changing a saving folder being set at a time that a through image is being displayed by the displaying processing portion, and the icon displaying processing portion displays an icon in a selectable manner at a time that an operation to the change icon is performed.

In the further embodiment, the change icon displaying processing portion (24, S11) displays the change icon (F) for changing the saving folder on the through image in a superposed manner. Then, if and when the change icon is operated, the icon displaying processing portion displays the icon.

According to the further embodiment, since the icon becomes to be displayed after the change icon is operated, visibility for the through image is increased.

In a still further embodiment, the change icon includes a saving icon corresponding to the saving folder.

In the still other embodiment, the saving icon (F) indicative of the saving folder being currently set is displayed together with the through image.

According to the still other embodiment, the saving icon is displayed together with the through image, and therefore, convenience or facility for the user in performing the imaging operation is increased.

In another embodiment, the setting portion sets, when a plurality of icons are simultaneously selected, a plurality of folders corresponding to the selected plurality of icons as a saving folder, and the saving portion saves the same imaged image in the set plurality of saving folders, respectively, at a time that the imaging operation is performed.

In this embodiment, if two icons, for example are simultaneously selected, folders respectively corresponding to the two icons are set as saving folders. Then, if the imaging operation is performed, the same imaged image is saved in each of the two folders.

According to this embodiment, it is possible to set a plurality of saving folders prior to the imaging operation, and therefore, it is possible to omit such a troublesome operation that the imaged image is copied after the imaging operation.

In a still another embodiment, a camera function includes a consecutive shooting function that consecutively performs the imaging and a selection function that selects an imaged image of good condition out of a plurality number of the imaged images imaged by the consecutive shooting function and the setting portion includes a consecutive shooting folder setting portion that sets a folder corresponding to the selected icon as a consecutive shooting folder for saving the imaged image of good condition selected by the selection function at a time that the consecutive shooting function of the camera image is made effective.

In this embodiment, the camera function has a consecutive shooting function capable of imaging a predetermined number of images (nine (9), for example) consecutively and a selection function capable of selecting an imaged image of good condition out of the predetermined number of the imaged images. The consecutive shooting folder setting portion (24, S45, S47) sets, if an icon is selected in a state that the consecutive shooting function is made effective, a folder corresponding to the icon as the consecutive shooting folder. Then, after the predetermined number of the images are imaged, the imaged image of good condition is saved in the consecutive shooting folder.

According to this embodiment, an operation for transferring a necessary image to another folder after the consecutive shootings becomes not needed.

A further embodiment further comprises a rearranging portion that rearranges the icons being displayed by the icon displaying processing portion in a predetermined order.

In the further embodiment, the rearranging portion (24, S19) rearranges such that the alignment of the icon becomes in an order of the saving numbers if and when a rearranging operation is performed.

According to this embodiment, because an order in that the icons are aligned can be changed, it becomes easy for the user to search a necessary icon.

Still another embodiment further comprises a pop-up displaying processing portion which displays a pop-up for receiving a changing operation of the saving folder being set at a time that an operation for performing a camera function is made, and the icon displaying processing portion displays an icon when the changing operation is performed.

According to the still another embodiment, the pop-up displaying processing portion (24, S3) displays a pop-up (P) including a change key (64) for changing the saving folder.

According to this embodiment, the user can change the setting of the saving folder when he/she performs the camera function.

A further embodiment is a folder managing method of a mobile terminal (10) which includes a storing portion (32, 34) in which at least a folder is set, a camera module (40-44), a display portion (30) which displays an image output by the camera module, and performs a camera function, comprising steps of: displaying (S1) a through image on the display portion based on an output of the camera module; displaying (S7) an icon (F1-F6) corresponding to the folder in a selectable manner at a time that a through image is being displayed; setting (S43-S49) a folder corresponding to a selected icon as a saving folder in which an imaged image is saved; and saving (S67) an imaged image in the saving folder at a time that an imaging operation is performed.

According to the further embodiment, the user can set such that the imaged image is saved in an arbitrary folder while seeing the through image, and therefore, the operability at a time of imaging is increased.

The other embodiment is a mobile terminal which includes a camera module, a display portion displaying an image that the camera module outputs, a touch panel provided on the display portion and a detecting portion detecting a touch operation within a touch range of the touch panel, and performs a camera function, comprising: a storing portion in which at least a folder is set; a displaying processing portion which displays a through image on the display portion based on an output of the camera module; a region setting portion which sets a specifying region corresponding to a folder within the touch range when a through image is being displayed by the displaying processing portion; a saving folder setting portion which sets, when a touch operation is made to the specifying region, a folder corresponding to the specifying region as a saving folder that an imaged image is saved; and a saving portion which saves an imaged image in the saving folder set by the setting portion when an imaging operation is performed.

In the other embodiment, a mobile terminal (10) includes a camera module (40-44) and a display portion (30), and an image based on an output of the camera module is displayed on the displaying portion. Furthermore, the display portion is provided with a touch panel (38), and a touch operation with respect to the touch panel is detected by a detecting portion. In a storing portion (32, 48), at least a folder is set. A displaying processing portion (24, S1) displays a through image on the displaying portion on the basis of the output of the camera module. A region setting portion (24, S7) sets a specifying region corresponding to the folder at a corner of a touch range or the like at a time the through image is being displayed. A saving folder setting portion (24, S35, S43-S49) sets if and when a touch operation is made to the specifying region provided at the corner of the touch area, for example, a folder corresponding to the specifying region as a saving folder to which an imaged image is saved. Then, a saving portion (24, S69) saves the imaged image in the set saving folder at a time that the imaging operation is performed.

In the other embodiment, the user can make setting so that an imaged image is saved in an arbitrary folder while seeing the through image. Accordingly, operability at a time of the imaging operation increases.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A mobile terminal which includes a camera module and a display portion displaying an image that the camera module outputs, and performs a camera function, comprising:
a storing portion in which at least a folder is set;
a displaying processing portion which displays a through image on the display portion based on an output of the camera module;
an icon displaying processing portion which displays an icon corresponding to the folder in a selectable manner at a time that the through image is being displayed by the displaying processing portion;
a setting portion which sets a folder corresponding to a selected icon as a saving folder in which an imaged image is saved; and
a saving portion which saves an imaged image in the saving folder that is set by the setting portion when an imaging operation is performed.

2. A mobile terminal according to claim 1, wherein the icon displaying processing portion displays a new icon corresponding to a new folder, further comprising a producing portion which produces a new folder in the storing portion if and when an operation to the new icon is performed, wherein the setting portion sets the new folder as a saving folder at a time that the new folder is produced by the producing portion.

3. A mobile terminal according to claim 1, further comprising a change icon displaying processing portion that displays a change icon for changing a saving folder being set at a time that a through image is being displayed by the displaying processing portion, wherein the icon displaying processing portion displays an icon in a selectable manner at a time that an operation to the change icon is performed.

4. A mobile terminal according to claim 3, wherein the change icon includes a saving icon corresponding to the saving folder.

5. A mobile terminal according to claim 1, wherein the setting portion sets, when a plurality of icons are simultaneously selected, a plurality of folders corresponding to the selected plurality of icons as a saving folder, and the saving portion saves the same imaged image in the set plurality of saving folders, respectively, at a time that the imaging operation is performed.

6. A mobile terminal according to claim 1, wherein the camera function includes a consecutive shooting function that consecutively performs the imaging and a selection function that selects an imaged image of good condition out of a plurality number of the imaged images imaged by the consecutive shooting function, and the setting portion includes a consecutive shooting folder setting portion that sets a folder corresponding to the selected icon as a consecutive shooting folder for saving the imaged image of good condition selected by the selection function at a time that the consecutive shooting function of the camera image is made effective.

7. A mobile terminal according to claim 1, further comprising a rearranging portion that rearranges the icons being displayed by the icon displaying processing portion in a predetermined order.

8. A mobile terminal according to claim 1, further comprising a pop-up displaying processing portion which displays a pop-up for receiving a changing operation of the saving folder being set at a time that an operation for performing a camera function is made, wherein the icon displaying processing portion displays an icon when the changing operation is performed.

9. A folder managing method of a mobile terminal which includes a storing portion in which at least a folder is set, a camera module, a display portion which displays an image output by the camera module, and performs a camera function, comprising steps of:
displaying a through image on the display portion based on an output of the camera module;
displaying an icon corresponding to the folder in a selectable manner at a time that a through image is being displayed;
setting a folder corresponding to a selected icon as a saving folder in which an imaged image is saved; and
saving an imaged image in the saving folder that is set by the setting portion at a time that an imaging operation is performed.

10. A mobile terminal which includes a camera module, a display portion displaying an image that the camera module outputs, a touch panel provided on the display portion and a detecting portion detecting a touch operation within a touch range of the touch panel, and performs a camera function, comprising:
a storing portion in which at least a folder is set;
a displaying processing portion which displays a through image on the display portion based on an output of the camera module;
a region setting portion which sets a specifying region corresponding to a folder within the touch range when a through image is being displayed by the displaying processing portion;
a saving folder setting portion which sets, when a touch operation is made to the specifying region, a folder corresponding to the specifying region as a saving folder that an imaged image is saved; and
a saving portion which saves an imaged image in the saving folder set by the setting portion when an imaging operation is performed.
